(19) United States
(12) Patent Application Publication
(10) Pub. No.: US 2010/0187752 A1
(43) Pub. Date: Jul. 29, 2010

(54) PRINT MEDIA PATH

(76) Inventors: Kevin T. Kersey, San Diego, CA (US); Timothy J. Carlin, San Diego, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/360,528

(22) Filed: Jan. 27, 2009

(51) Int. Cl. B65H 5/06; B62D 7/00

(52) U.S. Cl. 271/264; 83/106

(57) ABSTRACT

In one embodiment, a print media path includes: a first media path having a single lane for guiding a single strip of print media toward a print zone; and a second media path separate from the first media path and having two lanes for guiding two strips of print media simultaneously toward the print zone.

### BACKGROUND

In a “full bleed” inkjet printer, the printed image extends fully to one or more edges of the print media, without any margin. Usually ink is ejected beyond the edge of the print media so that the printed image actually runs past the edge of the media to help ensure a complete image on the print media. In a full bleed printer that feeds two parallel strips of roll fed web media into the print zone, the two strips should be separated to prevent ink “overspray” applied to one strip from marking the other strip.

### DRAWINGS

FIG. 1 is a block diagram illustrating one embodiment of an inkjet printer.

FIG. 2 is a perspective and partial section view of a dual media path, according to an embodiment.

FIG. 3 is an elevation view illustrating a single, un-slit media web strip moving along the part of a dual media path for a single media strip, according to an embodiment.

FIGS. 4-10 illustrate a sequence of operation for separating slit media web strips and moving the strips along the part of a dual media path for twin media strips, according to an embodiment.

FIG. 11 is a perspective and partial section view illustrating slit media sheet strips being moved along the part of a dual media path for twin media strips, according to an embodiment.

FIG. 12 is an elevation and partial section view illustrating a dual media path, according to an embodiment.

FIG. 13 is a perspective exploded view illustrating a transport roller and shifter assembly in the strip separator, according to an embodiment.

FIGS. 14-19 are elevation and perspective views illustrating operation of the strip separator, according to an embodiment.

### DESCRIPTION

Embodiments of the new dual media path were developed in an effort to separate twin media strips in a full bleed printer to help prevent ink applied to one strip from marking the other strip and to provide a “static” dual media path for both single and twin media strips as a more simple and reliable alternative to “dynamic”, adjustable guide dual media paths. The embodiments shown in the figures and described below are examples. Other embodiments are possible. Thus, nothing in the following description should be construed to limit the scope of the disclosure.

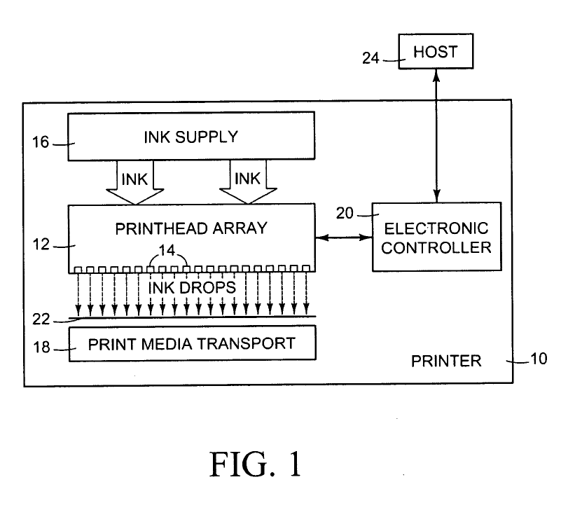

FIG. 1 is a block diagram illustrating an inkjet printer 10 that includes an array 12 of printheads 14, an ink supply 16, a print media transport system 18 and an electronic printer controller 20. Printer 10 illustrates one example of an environment for implementing embodiments of the new dual media path. Printhead array 12 in FIG. 1 represents generally one or more printheads 14 and the associated mechanical and electrical components for ejecting drops of ink or other marking material on to a sheet or continuous web of paper or other print media 22. In operation, printer controller 20 selectively energizes the ink ejector elements in a printhead, or group of printheads, in the appropriate sequence to eject ink on to media 22 in a pattern corresponding to the desired printed image.

Printhead array 12 and ink supply 16 may be housed together as a single unit or they may comprise separate units. Printhead array 12 may be a stationary larger unit (with or without supply 16) spanning the width of print media 22. Alternatively, printhead array 12 may be a smaller unit that is scanned back and forth across the width of media 22 on a moveable carriage. Media transport system 18 advances print media 22 lengthwise past printhead array 12. For a stationary printhead array 12, media transport 18 may advance media 22 continuously past the array 12. For a scanning printhead array 12, media transport 18 may advance media 22 incrementally past array 12, stopping as each swath is printed and then advancing media 22 for printing the next swath. Controller 20 may receive print data from a computer or other host device 24 and, when necessary, process that data into printer control information and image data. Controller 20 controls the movement of the operative components of media transport system 18. And, as noted above, controller 20 is electrically connected to printhead array 12 to energize the printhead ejector elements to eject ink drops on to media 22. By coordinating the relative position of array 12 and media 22 with the ejection of ink drops, controller 20 produces the desired image on media 22 according to the print data received from host device 24.

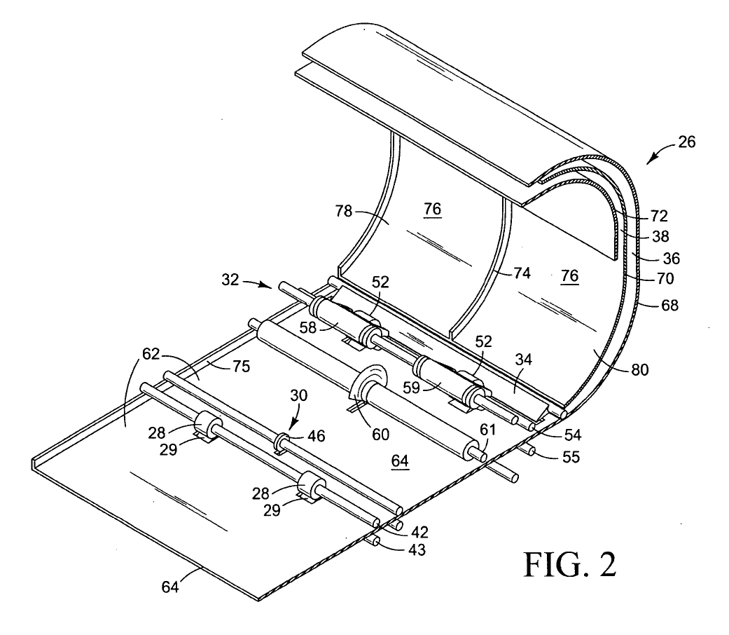

FIG. 2 is a perspective, partial section view of one embodiment of a new dual media path 26 that may be implemented, for example, as part of media transport system 18 in printer 10 shown in FIG. 1. Controller 20 in FIG. 1 represents generally the programming, processor and associated memory, and the electronic circuitry and components needed to control the operative elements of a printer 10, including the operative elements of media path 26 described below. The structural and operational details of motors, drive trains, sensors, switches and other conventional components well known to those skilled in the art of printer design are omitted from the following description of media path 26.

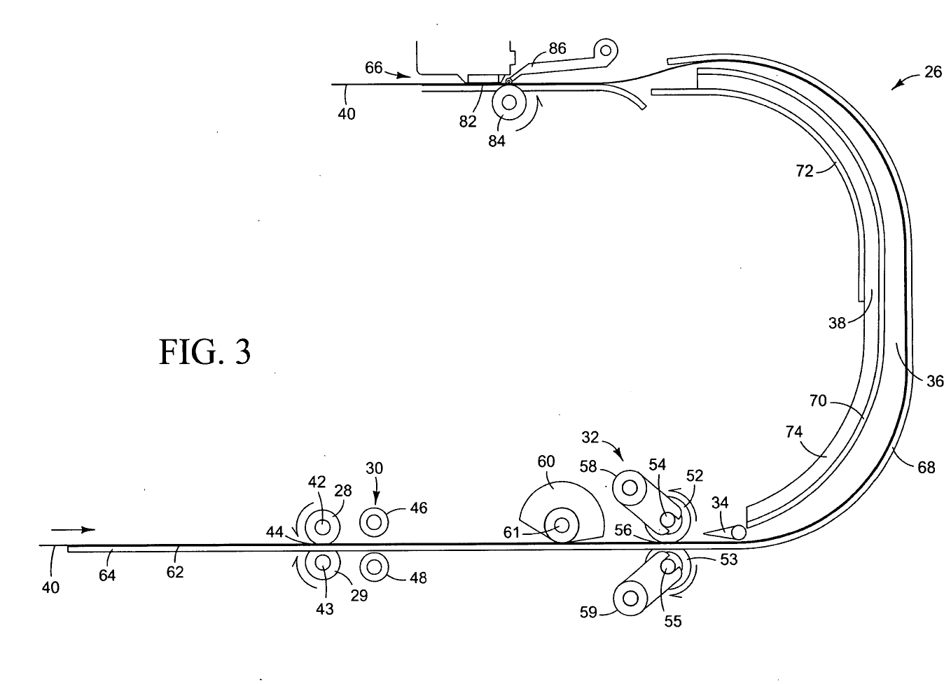

Referring to FIG. 2, dual media path 26 includes (from upstream to downstream) a set of first media transport rollers 28 and 29, a media slitter 30, a strip separator 32, a movable media guide 34, and single strip media path 36 and twin strip media path 38. FIG. 3 is an elevation view illustrating a single, un-slit media web strip 40 moving along media path 26. A “web” in this context refers to a long strip of print media typically fed from a roll as compared to a sheet of print media typically fed from a stack. For convenience, part number 40 is used to designate generally the full expanse of print media moved along path 26, including the print media as it enters path 26, a single, un-slit strip moved along path 36, and twin, slit strips moved along path 38.

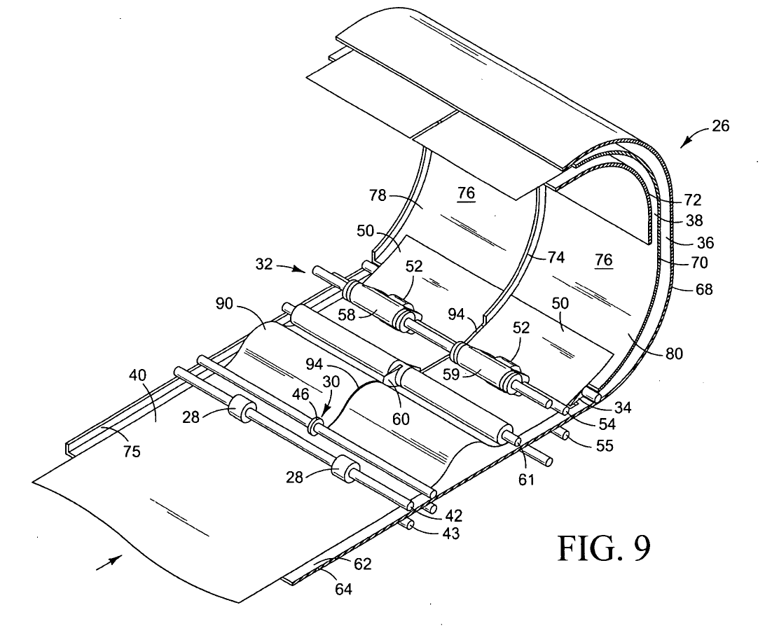

Referring to FIGS. 2 and 3, first transport rollers 28 and 29 are mounted to shafts 42 and 43, forming a nip 44 for gripping and moving media 40 along path 26. Although two pairs of transport rollers are shown, any suitable media feed mechanism may be used. One or both shafts 42 and 43 may be driven shafts that rotate one or both rollers 28 and 29. Where only one shaft is driven, top shaft 42 for example, then idler rollers 29 on a non-driven shaft 43 may turn freely on shaft 43 at the urging of driven rollers 28 acting through nip 44. Slitter 30 includes a cutting wheel 46 and an anvil 48. When wheel 46 and anvil 48 are engaged a single media strip 40 moving past slitter 30 is slit into twin strips 50 (FIG. 9). When wheel 46 and anvil 48 are not engaged, as shown in FIG. 3, then media strip 40 passes by slitter 30 un-slit. The particulars of slitter 30 are not important to the innovative aspects of the disclosure as long as slitter 30 may be selectively engaged and disengaged at the direction of controller 20 (FIG. 1). Thus, slitter 30 represents generally any suitable mechanism for selectively slitting or not slitting a media strip moving along media path 26.

Separator 32 includes a set of second media transport rollers 52 and 53 mounted to shafts 54 and 55, forming a nip 56 for gripping and moving media 40 along path 26. Separator 32 also includes a shifter 58 and 59 for each roller 52 and 53, respectively, and a spacer 60 that is selectively rotated into and out of media path 26 on a shaft 61, as described below. One or both shafts 54 and 55 may be driven shafts that rotate one or both rollers 52 and 53. Where only one shaft is driven, top shaft 54 for example, then idler rollers 53 on a non-driven shaft 55 may turn freely on shaft 55 at the urging of driven rollers 52 acting through nip 56.

Media path 26 includes a single lane, leading part 62 defined by a generally flat track 64 that diverges at guide 34 into single lane media path 36, which in the embodiment shown is a continuation of lane 62, and two lane media path 38. In the embodiment shown, paths 36 and 38 each trace parallel semicircular paths that redirect media 40/50 180° into a print zone 66 where paths 36 and 38 converge. Single lane media path 36 is bounded by an exterior track or barrier 68 and a middle track or barrier 70. Two lane media path 38 is defined by middle track 70 and an interior track or barrier 72. A divider 74 extending along an interior surface 76 of middle track 70 divides path 38 into two lanes 78 and 80. Edge guides 75 extend along the sides of media path 26. For clarity, edge guides 75 are omitted from the elevation views in the figures. Print zone 66 is depicted generally as including an ink cartridge or other such printhead array 82 and a transport roller 84 bearing against an idler arm 86 to form a nip that moves media 40/50 past printhead array 82.

In the configuration shown in FIG. 3, slitter 30 is disengaged, spacer 60 is rotated up out of media path 26 and guide 34 is set, at the direction of controller 20 (FIG. 1), to direct a single web strip 40 fed off a roll (not shown) along single lane media path 38 to print zone 66.

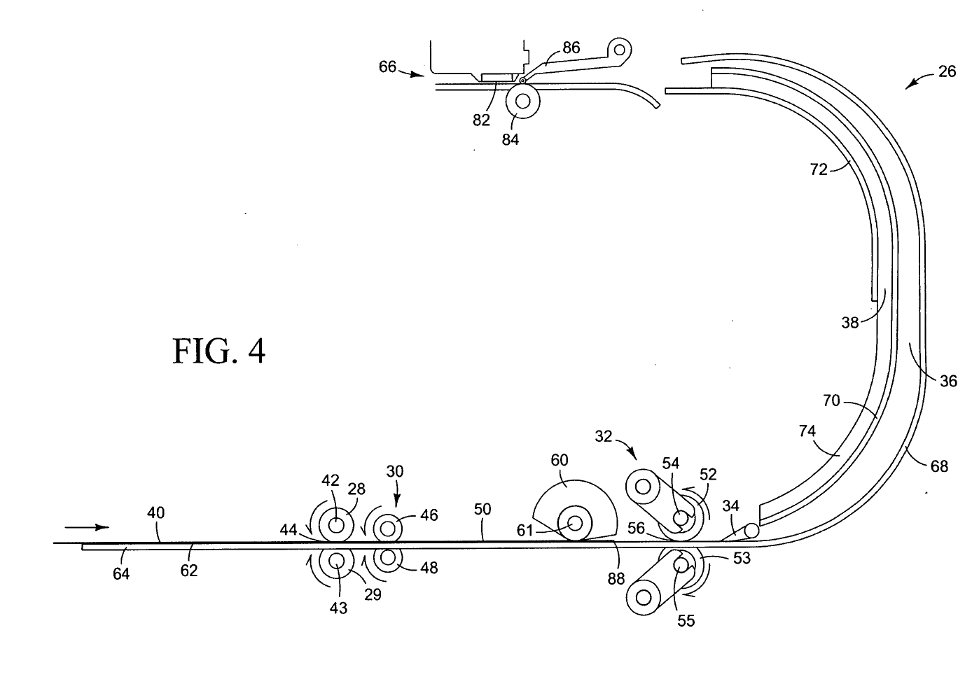

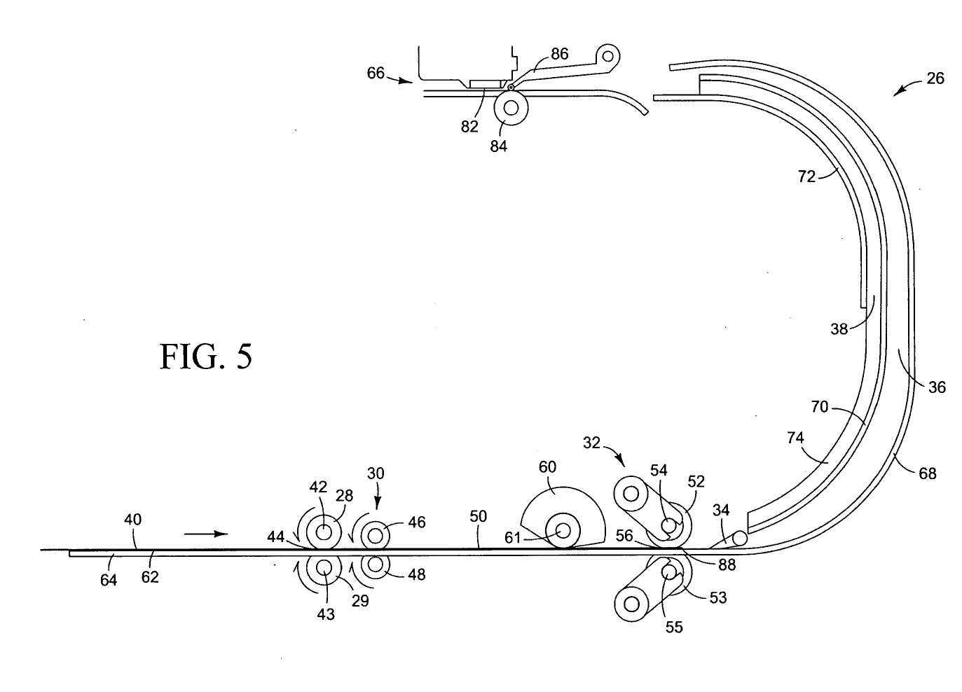

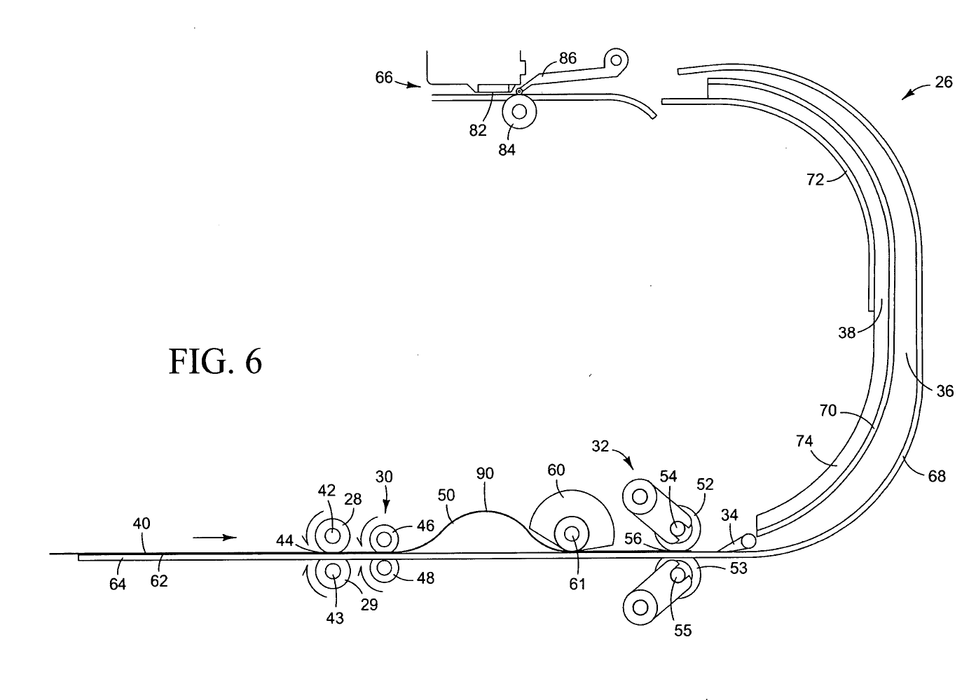

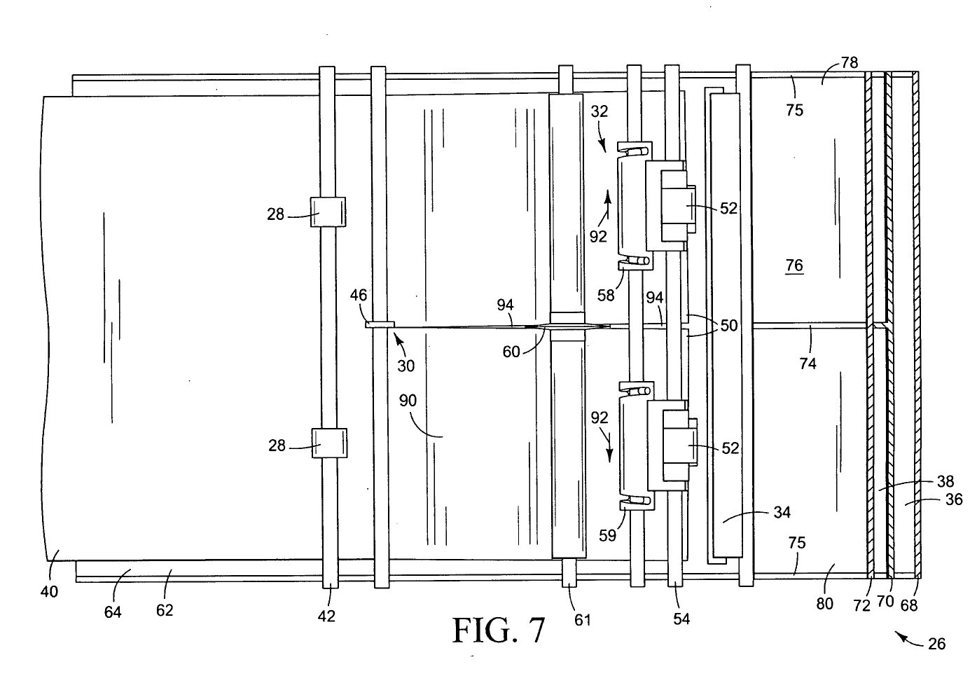

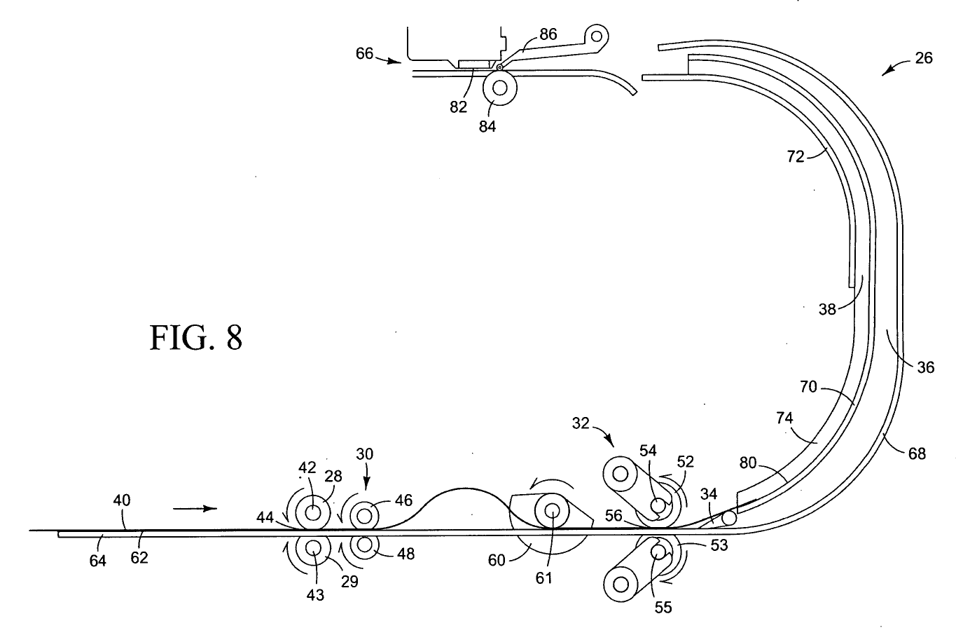

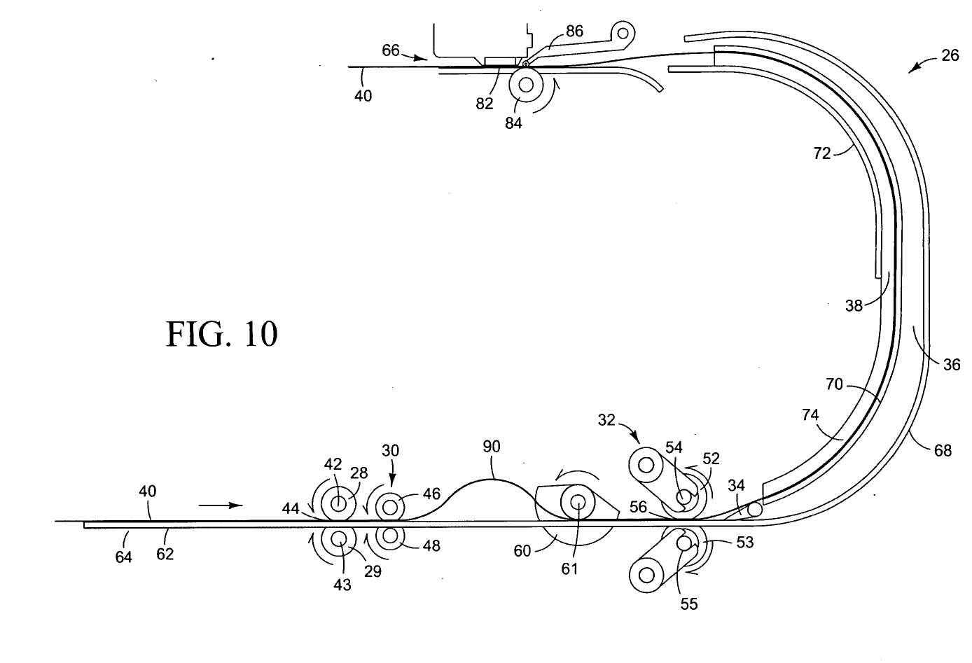

FIGS. 4-10 illustrate a sequence of operation for separating slit media web strips 50 and moving strips 50 along two lane path 38. (Twin strips 50 are best seen in FIG. 9.) In FIG. 4, rollers 28/29 and 52/53 are driven forward to move media 40 along path 26 and slitter 30 is engaged to slit a single media strip 40 into twin strips 50. When the leading edge 88 of media 40 has advanced into separator rollers 52/53, as shown in FIG. 5, rollers 28/29 continue to drive media 40 forward while rollers 52/53 are stopped to form a buckle 90 in media strips 50 between slitter 30 and separator 32, as shown in FIG. 6. Then, rollers 52/53 are shifted out axially along shafts 54 and 55, as indicated by arrows 92 in FIG. 7, to create a gap 94 between media strips 50. The grip at nip 56 of rollers 52/53, which are not rotating during the shift, keeps leading edge 88 of strips 50 properly aligned, parallel to the original axis. Guide 34 is set to guide media strips 50 into path 38. Spacer 60 is rotated down into gap 94, as best seen by comparing FIGS. 6 and 8, to help maintain gap 94 as twin strips 50 are fed toward print zone 66. Then, separator transport rollers 52/53 are again driven forward to move media strips 50 into lanes 78 and 80 on path 38, as shown in FIGS. 8 and 9. Transport rollers 28/29 and 52/53 are driven together in sync to advance media 40 and twin strips 50 along path 38 and into print zone 66, as shown in FIG. 10. Buckle 90 helps provide the flexibility required for separating media 40 into twin strips 50, creating gap 94, and for keeping strips 50 parallel with a consistent gap 94 as strips 50 are fed toward print zone 66.

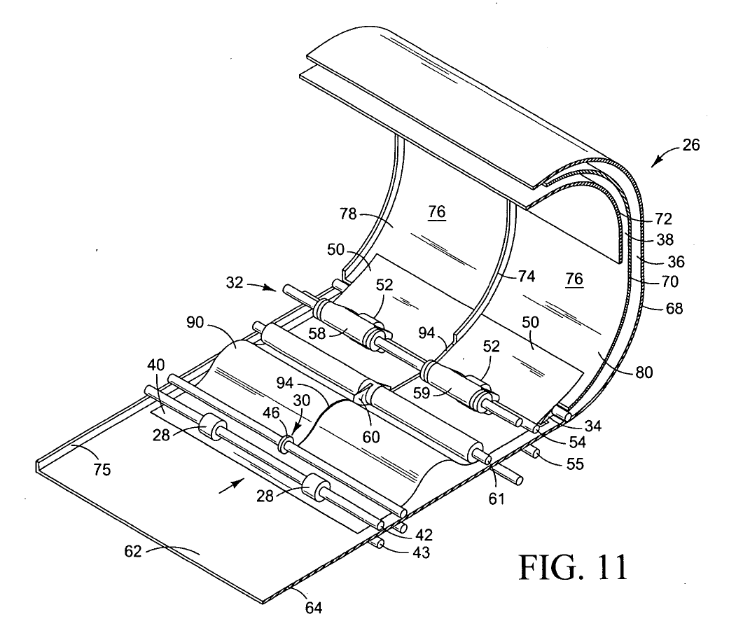

While it is expected that embodiments of the new dual media path will usually be used with a continuous web, roll-fed type print media 40 described above, embodiments might also be implemented with sheet media 40 as shown in FIG. 11. Also, although a twin strip slitter and separator are shown and described for a two lane path 38, more than two strips and more than two lanes may be possible. Thus, the reference to two lanes, twin strips and the like herein does not necessarily exclude three or more lanes.

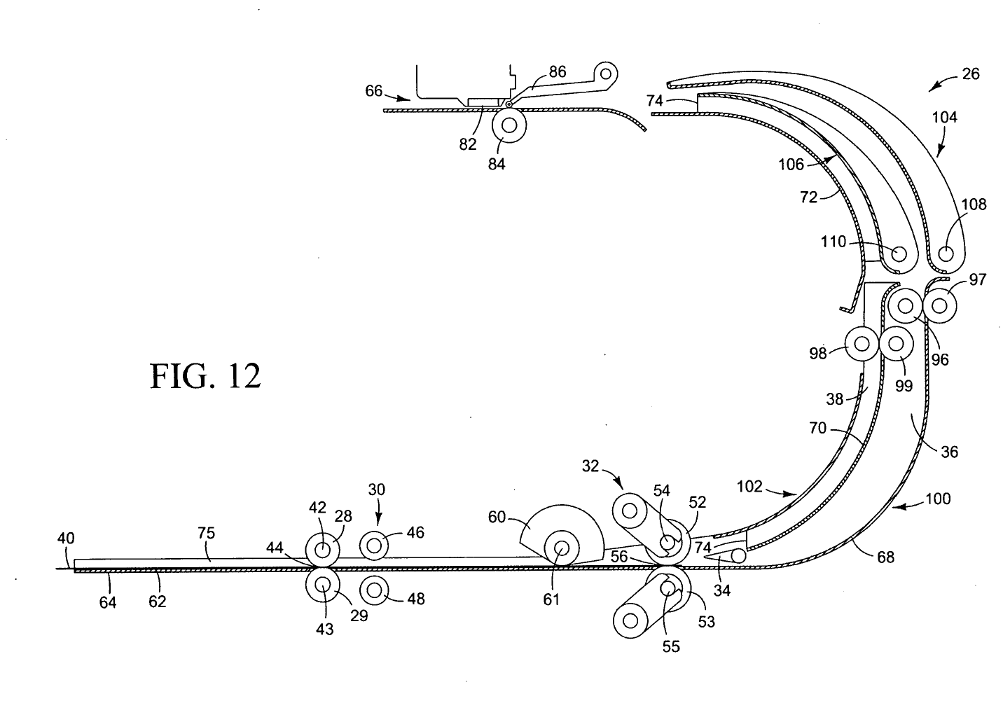

In an embodiment shown in the elevation and partial section view of FIG. 12, additional sets of media transport rollers 96, 97 and 98, 99 are positioned in single lane path 36 and two lane path 38, respectively. Depending on the length and direction of media paths 36 and 38 between separator 32 and print zone 66, intermediate transport rollers 96, 97 and 98, 99 may be desirable to more effectively move slit and/or un-slit media to print zone 66. Also, in the embodiment shown in FIG. 12, each media path 36 and 38 in constructed in two discrete parts. First, lower parts 100, 102 of paths 36, 38 provide a continuous transition from leading part 62 of media path 26 to guide the print media through 90° of travel into transport rollers 96, 97 and 98, 99. Second, upper parts 104, 106 guide the print media through the remaining 90° of travel to print zone 66. Upper parts 104 and 106 may be hinged at pins 108 and 110 to allow each part 104 and 106 to swing open to expose media paths 36 and 38.

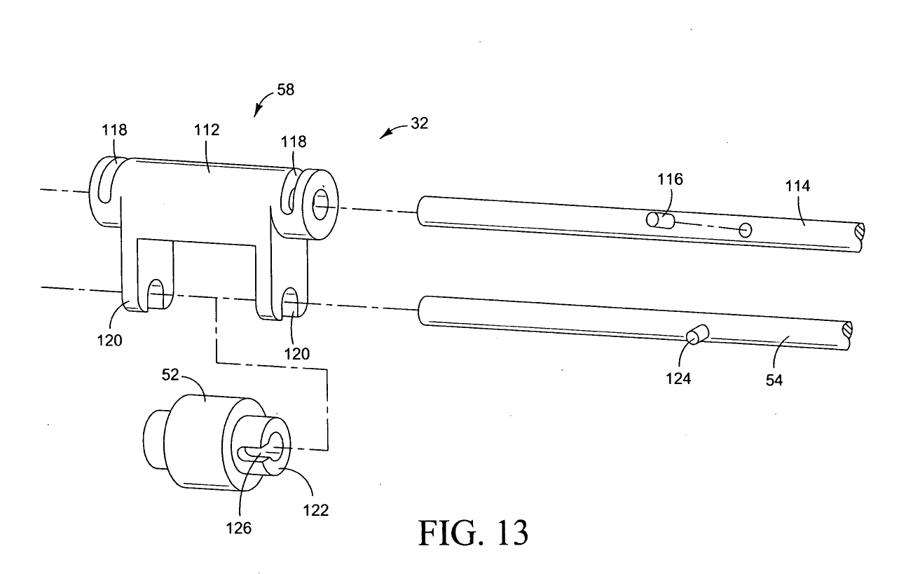

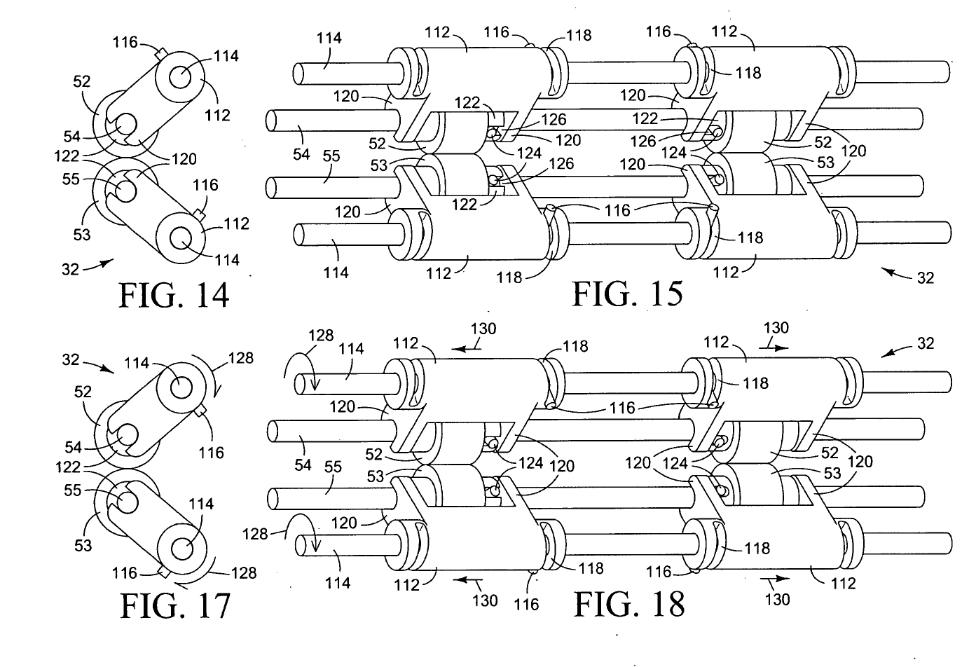

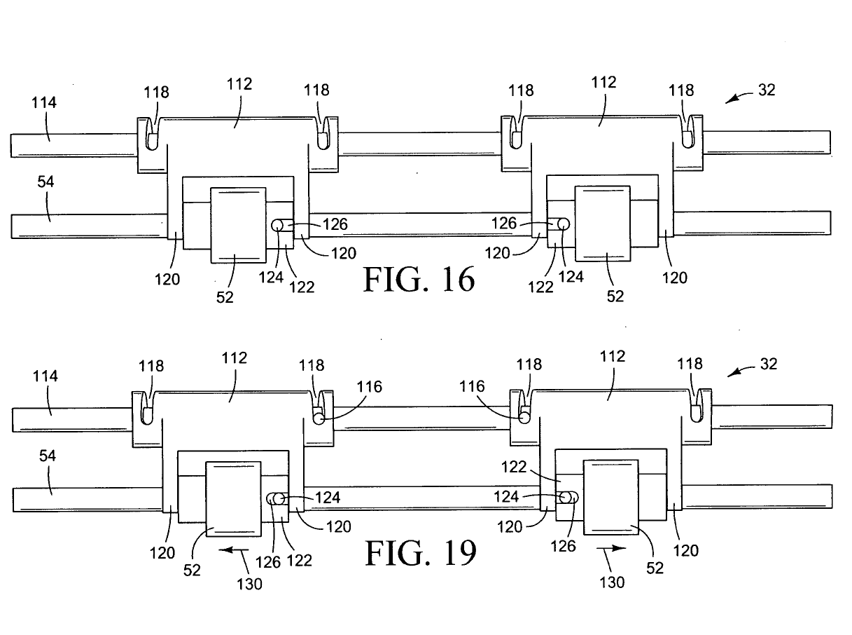

FIGS. 13-19 are perspective and elevation views illustrating one embodiment of a separator 32. FIGS. 14-16 show separator 32 in the unexpanded position corresponding to an un-slit media strip 40. FIGS. 17-19 show separator 32 in the expanded, gapped position corresponding to slit media strips 50. Referring first to FIG. 13, the body 112 of each shifter 58 and 59 is mounted to an actuator shaft 114 and to one of the roller shafts 54, 55 such that shifter body 112 may slide axially along shaft 114. An actuator pin 116 affixed to shaft 114 travels in an angled slot 118 that extends radially around a portion of shifter body 112. Shifter body 112 is mounted to shaft 54 or 55 through a pair of forks 120 fitted to shaft 54, 55. Forks 120 straddle roller 52, 53 on shaft 54, 55 such that roller 52, 53 moves axially along shaft 54, 55 when shifter body 112 is moved axially on shaft 114. Each roller 52, 53 is mounted on a drive shaft 54, 55 through a hub 122 such that hub 122, and accordingly each roller 52, 53, may slide axially along shaft 54, 55. A drive pin 124 affixed to each drive shaft 54, 55 positioned in an axial slot 126 in hub 122 transmit the driving force of shaft 54, 55 to hub 122 and rollers 52, 53. (For this embodiment of separator 32, rollers 52 and 53 are driven on shafts 54 and 55, respectively. For embodiments of separator 32 in which idler rollers are utilized, rollers 53 for example, then drive pin 124 is omitted for a driven shaft 55 or shaft 55 is configured as an un-driven, idler shaft.)

A shifting sequence will now be described with reference to FIGS. 14-19. FIGS. 14-16 show separator 32 in the unexpanded position corresponding to an un-slit media strip 40. FIGS. 17-19 show separator 32 in the expanded, gapped position corresponding to slit media strips 50. To expand rollers 52, 53, both actuator shafts 98 are rotated clockwise simultaneously as indicated by arrows 128 in FIGS. 17 and 18 to turn actuator pins 116 in angled slots 118 in each shifter body 112. The rotating pins 116 bear against the sides of the angles slots 118 and push each body 112 axially outward along shaft 114, as indicated by arrows 130 in FIGS. 18 and 19. Accordingly, forks 120 acting on hubs 122 push rollers 52, 53 outward along shafts 54, 55. Thus, media strips 50 gripped at nips 56 are separated to the desired gap 94 (FIG. 7). Rotating actuator shafts 114 counter-clockwise from the expanded position drives rollers 52, 53 axially inward to the un-expanded position shown in FIGS. 14-16.

The present disclosure has been shown and described with reference to the foregoing exemplary embodiments. It is to be understood, however, that other forms, details and embodiments may be made without departing from the spirit and scope of the disclosure which is defined in the following claims.

What is claimed is:

1. A print media path in a printer, comprising:
a first media path having a single lane for guiding a single strip of print media toward a print zone; and
a second media path separate from the first media path and having two lanes for guiding two strips of print media simultaneously toward the print zone.

2. The path of claim 1, further comprising a guide movable between a first position for guiding a single strip of print media into the first media path and a second position for guiding two strips of print media simultaneously into the second media path.

3. The path of claim 2, further comprising a media slitter upstream from the movable guide, the slitter operative between an engaged position for slitting a single strip of print media moving along the path into two strips of print media and a disengaged position for not slitting the print media.

4. The path of claim 3, further comprising a pair of rotatable media transport rollers for engaging print media and moving the print media along the media path, the transport rollers spaced apart from one another across the media path between the slitter and the movable guide and each roller operative while engaging the print media from a first lateral position to a second lateral position in which the rollers are farther apart than in the first lateral position.

5. The path of claim 4, wherein both rollers are operative simultaneously from the first lateral position to the second lateral position while each roller engages a corresponding one of two strips of print media,.

6. The path of claim 4, wherein the guide is in the first position for guiding a single strip of print media into the first media path when the transport rollers are in the first lateral position and the guide is in the second position for guiding two strips of print media simultaneously into the second media path when the rollers are in the second lateral position.

7. The path of claim 1, wherein the first and second media paths are substantially parallel to one another.

8. The path of claim 1, wherein the first and second media paths converge with one another approaching the print zone.

9. The path of claim 1, wherein each strip of print media comprises a web of print media or a sheet of print media.

10. The path of claim 1, wherein the two lanes of the second media path are positioned side by side and separated by a divider.

11. A print media path in a printer, comprising:
a first media path having a single lane for guiding a single media web toward a print zone;
a second media path substantially parallel to the first media path, the second media path having two lanes positioned side by side and separated by a divider for guiding two strips of a slit media web simultaneously toward the print zone; and
the first and second media paths diverging from a single media path at an upstream location and converging into a single media path at a downstream location near the print zone.

12. A print media path in a printer, comprising:
a print zone in which a marking material may be applied to a print media;
a slitter upstream from the print zone for slitting into strips print media moving toward the print zone along a media feed path;
a pair of media transport rollers between the slitter and the print zone, the rollers mounted to a shaft that extends across the media feed path, the rollers rotatable with the shaft for moving print media along the media feed path and the rollers movable axially along the shaft for forming a gap between strips of slit media; and
a shifter operatively coupled to the transport rollers for simultaneously shifting both rollers axially along the drive shaft, while engaging strips of print media, from an inboard position to an outboard position in which the rollers are farther apart than in the inboard position, to form a gap between media strips.

13. The path of claim 12, further comprising a spacer near the shifter, the spacer movable between a first position out of the media feed path and a second position in the media feed path in the gap between media strips.

14. The path of claim 12, further comprising:
a first part of the media feed path having a single lane for guiding a single strip of print media toward a print zone;
a second part of the media feed path having two separate lanes for guiding two strips of print media simultaneously toward the print zone; and
a guide downstream from the transport rollers, the guide movable between a first position for guiding a single strip of print media into the first media path and a second position for guiding two strips of print media simultaneously into the second media path.

15. A print media path in a printer, comprising:
a print zone in which a marking material may be applied to a print media;
a slitter upstream from the print zone for slitting print media moving toward the print zone into strips;
a media transport for moving print media through the slitter toward the print zone;
a media separator between the slitter and the print zone downstream from the first media transport roller, the media separator operative:
while the media transport is moving print media toward the print zone, to stop a leading part of the print media from moving toward the print zone such that a buckle forms in a trailing part of the print media between the separator and the media transport;
forming a gap between buckled print media strips; and then
moving the leading part of the print media toward the print zone.

16. The path of claim 15, wherein the separator comprises:
a first pair of rollers coming together at a first nip and a second pair of rollers coming together at a second nip spaced apart laterally across the media feed path from the first nip;
a shifter operatively coupled to the first and second pairs of rollers, the shifter operative to simultaneously shift both pairs of rollers from an inboard position to an outboard position in which the nips are farther apart than in the inboard position.

17. The path of claim 15, further comprising:
a first part of the media feed path downstream from the separator having a single lane for guiding a single strip of print media toward a print zone; and
a second part of the media feed path downstream from the separator having two separate lanes for guiding two strips of print media simultaneously toward the print zone.
